(19) United States
(12) Patent Application Publication
(10) Pub. No.: US 2008/0224473 A1
(43) Pub. Date: Sep. 18, 2008

(54) Roto-synchronous electric motor

(76) Inventor: Chester White, New York, NY (US)

Correspondence Address: Chester White, P.O. Box 730647, Elmhurst, NY, 11373, US

(21) Appl. No.: 12/009,898

(22) Filed: Jan. 22, 2008

Related U.S. Application Data
(60) Provisional application No. 60/881,220, filed on Jan. 20, 2007.

(51) Int. Cl. F01D 15/10; F01D 15/02; H02K 1/27

(52) U.S. Cl. 290/52; 310/114; 310/83

(57) ABSTRACT

An electric motor for an automobile is herein introduced as a power source which does not require gas or any other fuel of any kind; nor does it require solar power, batteries, nor fuel cells for its operation. The vehicle will be powered by the dynamics of the physical dynamics of the electromagnetic forces of momentum. This novel idea drastically alters the perception of the automobile with its internal combustion engine, need for a radiator, muffler, anti-freeze, etc. In fact, this vehicle does not have what is usually thought of as an “engine.” It operates under the dynamics of physical laws of electromagnetic force for mechanical propulsion and strength of torque for horsepower. Otherwise, it operates in the same conventional manner as does the typical passenger automobile. Moreover, this novel idea addresses the adverse effects of air pollution upon human health, environmental ecology, global oil depletion, and protracted monetary expense.

This application references Provisional Application No. 60/881,220 Filed Jan. 20, 2007 for date of priority.

### BACKGROUND

1. Field of Invention

This invention relates to passenger automobiles, load-bearing, conveyance, motorcycles, and water craft vessels—in addition to stator-rotary apparatus products all of which do not require liquid, fossil, or combustible fuel of any kind for their operations; they do not require the typical battery recharging processes now used with respect to the present-day “concept cars;” nor do they use solar power or solar energy for propulsion.

2. Description of Prior Art

It is known that many attempts have been made to invent a passenger automobile which utilizes the least amount of liquid fuel for operation of the vehicle. The present invention does not use fossil fuel. On the contrary, it operates on principles of the physics of electromagnetism. Together with the physical dynamics of centrifuge, momentum, fulcrum, inertia, centrifugal force, centripetal force, impetus, torque, magnetism, electromagnetism, mass/rpm factor, turbine energy, etc. The idea for this concept supersedes all others in that it addresses vital environmental situations which are regularly emphasized in regards to automobile emissions, in addition to the ongoing dependence on foreign oil production, its import, and concerns for its eventual global depletion. There appears to be no automobile engine of record which addresses the dilemma herein-stated as does the present invention of a roto-synchronous electric motor.

As concerns the component electromagnetic system structured into present invention, Dukowicz et al., U.S. Pat. No. 3,815,511, Jun. 11, 1974, introduces a magnetic propulsion and levitation system for high speed vehicles to travel over an established roadbed. Through sequentially-energized coils operating with superconducting magnets, the vehicle is propelled for locomotion. It is akin to the “Mag-Lev” technology extant in several foreign countries. Though this system is well for high-speed, high-occupancy transportation, it does not address the, essentially, more inexpensive undertaking for expediting a truly, more personal, (individualized) transportation implementation introduced by the present invention. Such technology and relevant infrastructure required to effectuate the Dukowicz et al. system would require an immense effort in regards to lobbying governments for huge financial considerations.

Both the Dukowicz et al. system and that of Johnson, U.S. Pat. No. 5,402,021, Mar. 28, 1995, utilize both electromagnetic and permanent magnet systems for the propulsion of a vehicle. The vehicles designed to carry larger numbers of passengers than the accommodations presumed for the present invention: one to six persons as in the typical passenger automobile.

The Rotary Magnet Device introduced by D. J. Cunningham, U.S. Pat. No. 4,443,776, Apr. 17, 1984, discloses “at least two circular arrays of wedge-shaped magnetized elements” which can create a magnetic field bringing about a rotary motion once the magnetic field of the respective arrays are brought together to interact. However, this system does not approximate the novel element of two spinning discs, horizontally-stacked whose opposite, magnetized spin, (clockwise & counterclockwise) would cause an interfacing “drive shaft” gear head to rotate, making conventionally connected differential gears to effectively turn under the control of the operator.

The only prior art found that is remotely similar to the present invention is that of the Magnetic Propulsion System introduced by Thomas J. Clapham, U.S. Pat. No. 3,927,620, Dec. 23, 1975. Nevertheless, the Clapham system, though utilizing electromagnetic dynamics and levitation elements for the propulsion, the overall institution of such system would, as fore-stated in regards to the above-mentioned propulsion vehicles are, first of all, not for unproblematic ease of implementation in society. Cost factors for investment and huge technological factors are involved. The relevant comparison between the Clapham system and the present invention entails the factor of singular operator for personal utilization by persons desiring at any one given time to “go for a drive” to wherever one wants. Nevertheless, the necessities for implementation for one over the other constitute the rationale for priority for the present invention, Roto-synchronous Electric Motor.

### OBJECTS AND ADVANTAGES

More important than the obvious deleterious factors involved with cost and negative environmental concerns involved with implementation of the innovations above, the present Roto-Synchronous Electric Motor provides:

a. to provide an electric motor which will use no gasoline or any other fossil fuel.

b. to provide electric motor which will allow the consumer to save an immense amount of capital resources now being spent on gasoline.

c. to provide an electric motor which will allow a more trouble-free automobile which will not have the usual motor and engine breakdown and repair required by conventional automobiles. There will not be the friction and heat buildup as is common in today's internal combustion engines.

d. to provide an electric motor which will provide the same, or better, performance with regard to horsepower and overall efficacy of operation.

e. to provide an electric motor which will promote a strategy for “Energy Independence for the United States and other areas of the world community.

More important than the obvious beneficial factors involved with cost and addressing the negative environmental concerns involved with implementation of the novel apparatus above, the Roto-Synchronous Electric Motor also addresses other, “quality-of-life,” (health) issues. It will address the ongoing concerns that society, at large, has for the quality of the environment in the eco-system. An automobile which does not spew any automobile exhaust emissions into the air will constitute an immense benefit in promoting the preservation of respiratory health and, as a consequence, (for those who have challenged immune systems) life itself.

### SUMMARY

The present invention will operate encompassing the dynamics of the physical laws of an electromagnetic polarity switching process and consequent momentum forces arising from the clockwise and counterclockwise spin of two discs affixed to which are permanent magnets and electromagnets whose alternating interfacing polarities cause alternating attraction and repulsion and consequent propulsion of a personal conveyance vehicle and other apparatus products.

### DRAWINGS

### Page 1

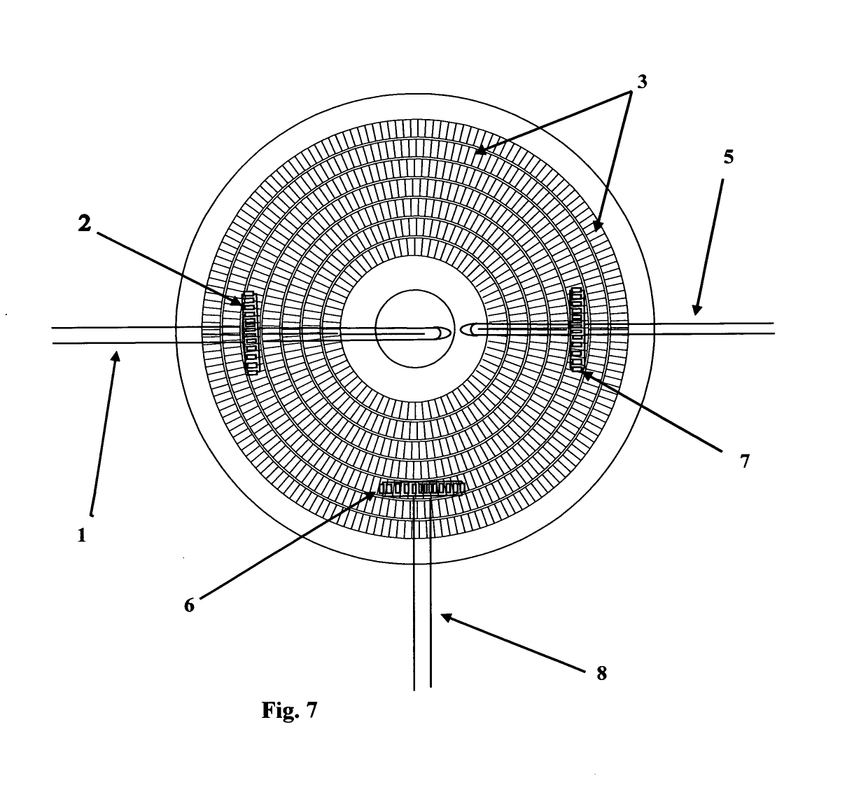

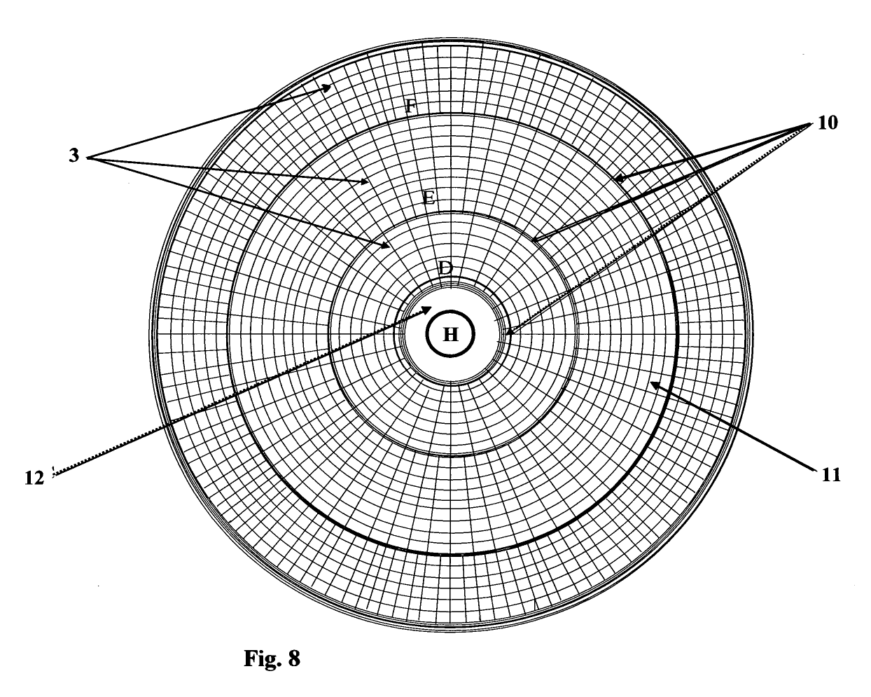

This is a superposed view of magnet arrangements of the underside of “2” disc above the topside of “4” disc as seen from above. The figures in bold 6 are electromagnets that are on the Stator Disc, 2. These magnets and disc do not rotate but attract and repel, (polarity switching) the non-bold FIGS. 8 which are permanent, “rare-earth,” magnets. Such attraction and repulsion cause “rotation” of the Rotor Disc, 4, in a counterclockwise direction. This mutual attraction and repulsion of magnets is duplicated, in reverse tandem, with respect to the C and D discs with the C disc being the Rotor disc and the D disc as the stator. See pages 10 and 12 for side view this disc assembly. The following two pages show the next two stages.

### Page 2

This diagram shows electromagnets 6 and permanent magnets 8 at full attraction capacity; at this point, there is a simultaneous polarity shift of the electromagnets causing the electromagnets and permanent magnets to repulse each other.

### Page 3

This diagram shows electromagnets and permanent magnets at full repulsion capacity after polarity shift. The attractive and repulsive forces cause the respective Drive Discs, 2 & 4, to spin in opposing clockwise and counterclockwise directions. 2: Stator Disc, (with electromagnet) 4: Rotor Disc, (with permanent magnet)

### Page 4

This diagram shows electromagnets 6 and permanent magnets 8 at “equidistant opposite” to each other after having gone “full cycle” for one event of attraction and repulsion. It shows an “identical aspect” for magnet arrangement of diagram one.

### Page 5

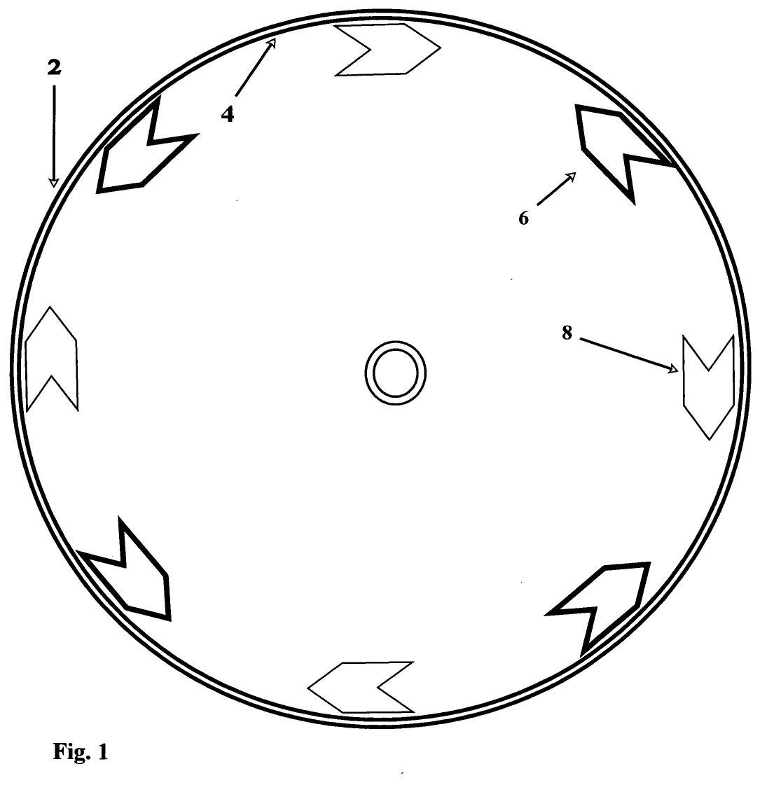

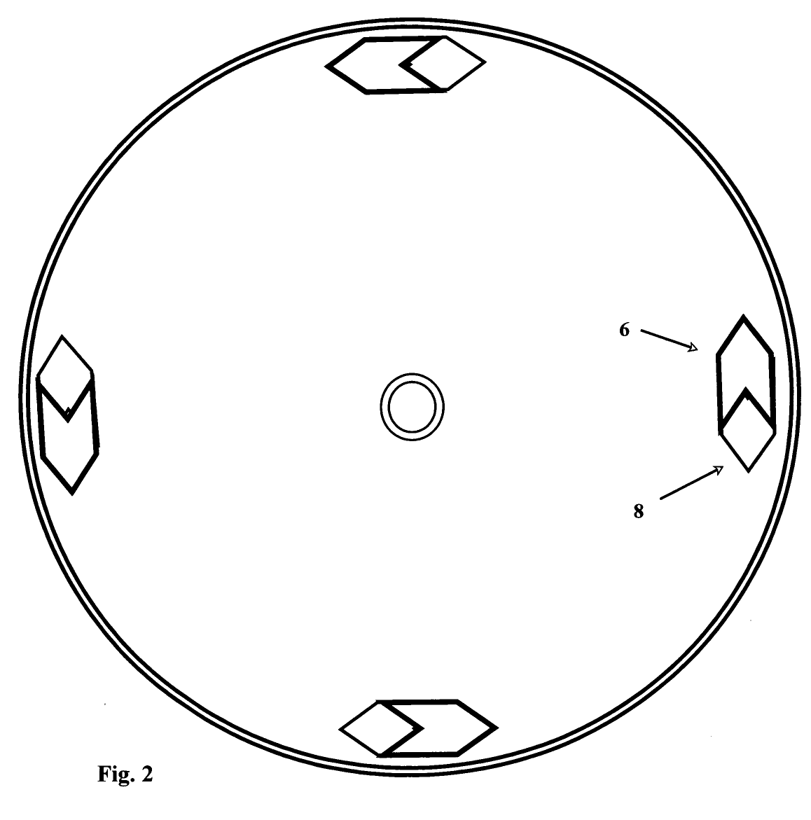

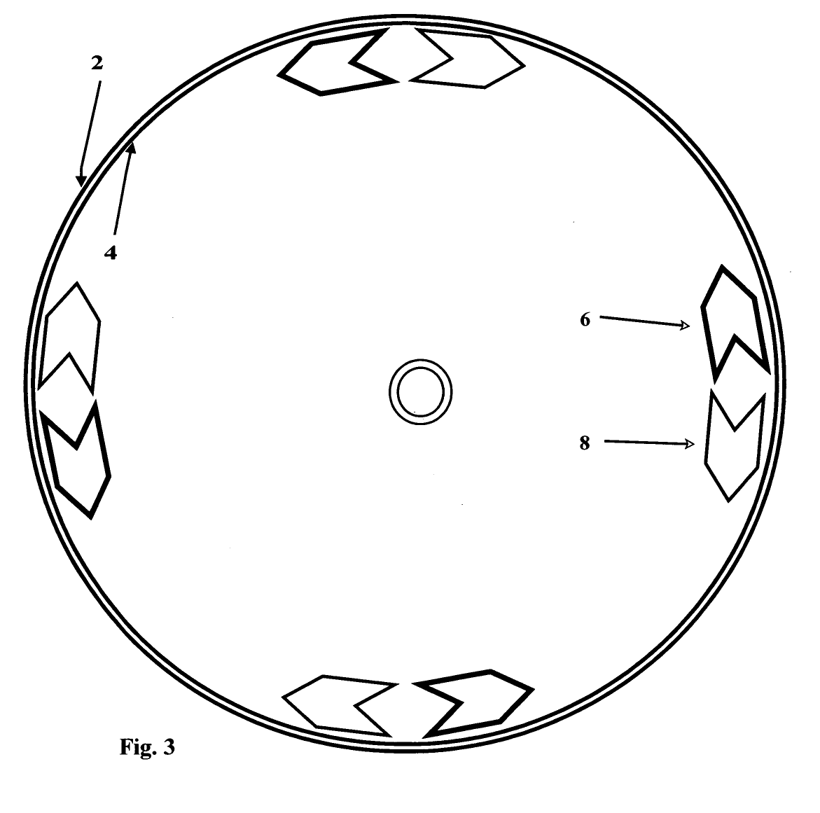

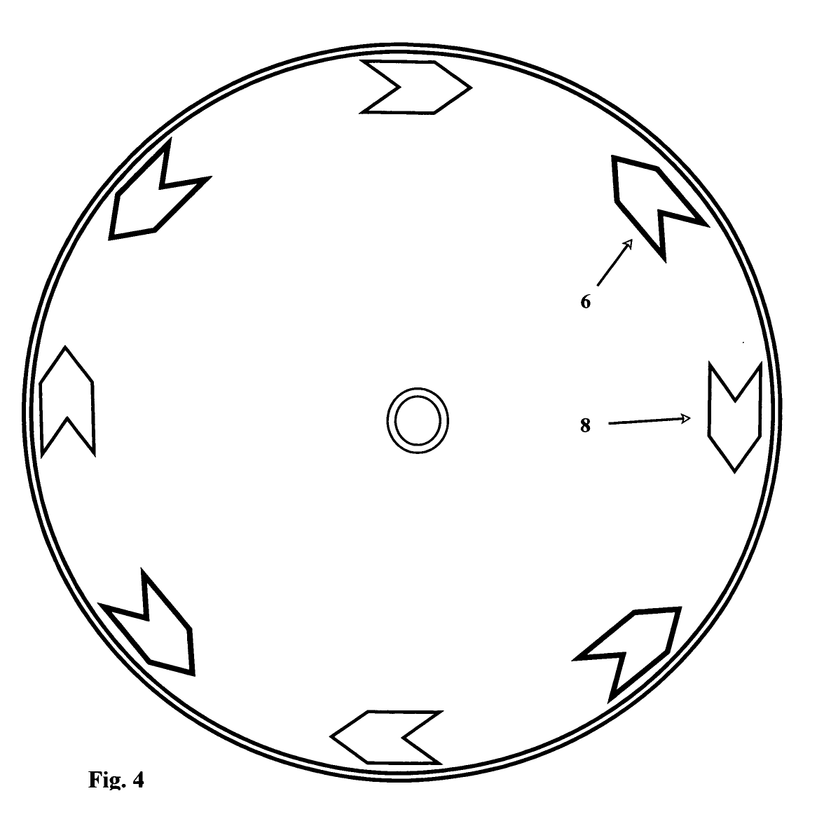

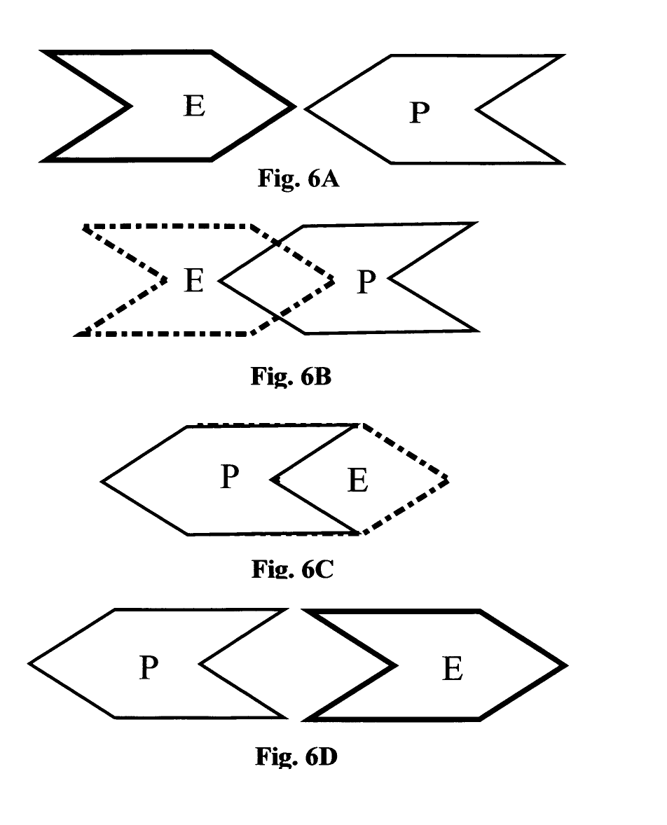

I. Shows a schematic of the various electrical, power generating, and controller systems for the necessary operation of the novel Roto-Synchronous Electric Motor. It Shows proximity relationships of P: permanent magnets and E: electromagnets as they interface with each other on their respective drive discs. It shows interactive relationships of some of the principal components of the motor assembly. FIG. 6A Shows the natural attractive force of North/South, (opposite) poles of electromagnet, “E,” and permanent magnet, “P,” as they approach each other on their respective discs. FIG. 6B Shows electromagnet and permanent magnet as they begin to overlap. FIG. 6C Shows electromagnet and permanent magnet as they are at maximum attractive force. It is at this moment that the poles of the electromagnets are to switch for maximum repulsive force causing the continuous spin of the Rotor Discs. FIG. 6A Shows complete cycle of one set of electromagnets and permanent magnets.

### Page 6

This page shows the C-Rotor Disc in propulsion configuration for both automobiles and aircraft.

1: Drive Shaft for posterior gear box and rear wheels

2: Gear Head for torque action of Posterior Drive Shaft

3: Rows into which Gear Heads, G, run and between which they transit.

4: Drive Shaft for anterior gear box and front wheels

5: Rotor for Turbine mechanism. It transits the various rows as the need for electric power requires.

6: Turbine Shaft that leads to the Induction Generator

7: Gear Head for dynamic torque action of Anterior Drive Shaft. Note: In the case of aircraft, the process of the Drive Shaft A does NOT transit forward to interact with G to effect a “reverse” torque as would be the process for automobiles. Both B and G remain in their respective tiers throughout.

### Page 7

Page 7 shows C-Rotor Disc.

10: Tier separators. These are the segments at which a tooled adjustment is made for the “cooperation” of length of striation, G. Such adjustment is necessary for the gear head teeth to be correctly matched for each row as gear head transits out toward periphery and in toward the center.

11: Rows into, and along, which the gear heads will run and mesh with striation/grooves. As concerns MPH velocity of automobile, each row will represents a “plateau” at which speed can be modulated for increase or decrease.

12: “Neutral Gear Zone” Gear Heads don't mesh in this area. Vantage point is from above observing the “C” disc.

D: First Tier—where both inertia and torque are at their highest. Striations are equidistant to prevent gear gnashing.

E: Second Tier—going out from center as momentum and speed increase. Striation measurements are maintained.

F: Third Tier—As gear heads transit out toward the peripheral edges, RPM's of tachometer increase specifying, also, the velocity and speed of vehicle. Each row of each tier can be thought of as increments of MPH as gear head transits each row toward periphery.

3: Striation/Grooves into which gear-head teeth mesh for the turning, torque, action of front and rear Drive Shafts.

H: Central support column upon which all four discs, (A, B, C, & D—“Stacked”) are supported and around which disc B and disc C spin—in opposite directions—providing turning motion for gear heads and dynamic torque power for the drive shafts.

### Page 8

10: The grooved recess on both front and rear drive shafts, B & G, necessary for gear heads to lock for turning motion.

19: Rear Drive Shaft

20: Rear Drive Shaft Gear Head. This diagram shows it being brought forward to the non-engaged position. The Drive Shaft advances forward displacing the anterior Drive Shaft by taking its Gear Head. Such configuration is for “reverse.” As it advances still forward, speed in reverse increases.

21: Central Support Column for the Drive discs.

22: Switching mechanisms for leading the gear heads from one row to the next effecting variation in speed of vehicle.

23: Front Drive Shaft Gear Head showing, in this diagram, how the rear drive shaft advances forward taking the gear head of Front Drive Shaft. This is the sequence for “reverse” drive.

24: Anterior, (front) Drive Shaft. In this position, it has withdrawn from the Gear Head to allow posterior Drive Shaft to possess anterior gear head. This is the configuration for the “reverse” mobility of the vehicle.

25: Head of Rear Drive Shaft protruding through “D” & anterior gear head for the reverse drive of the vehicle. Anterior Drive Shaft withdraws from its own gear head to allow Posterior Drive Shaft to possess its gear head for reverse movement of vehicle.

### Page 9

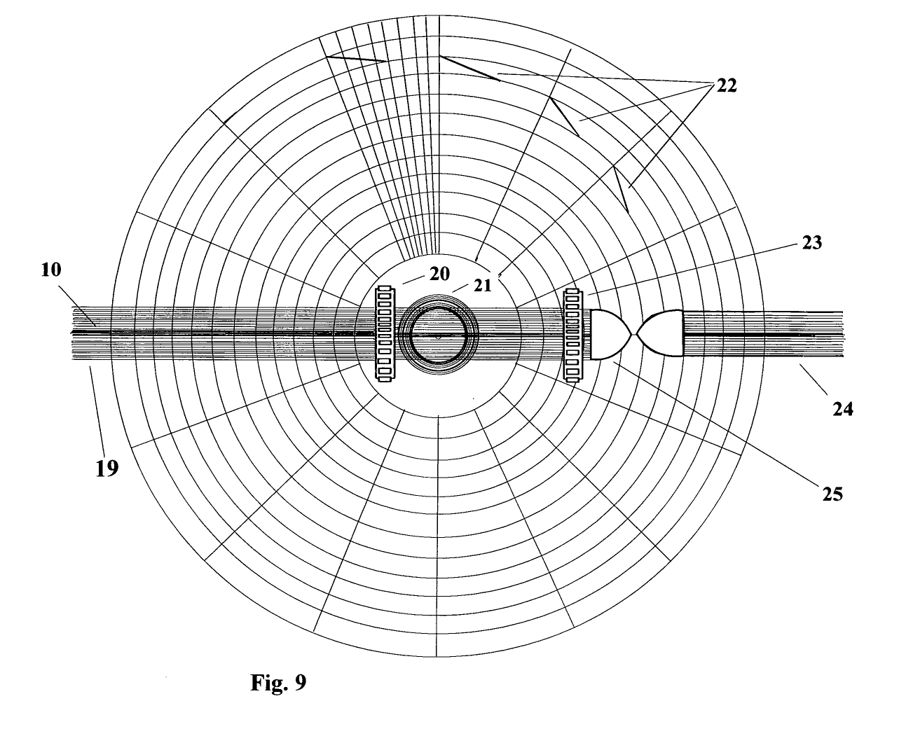

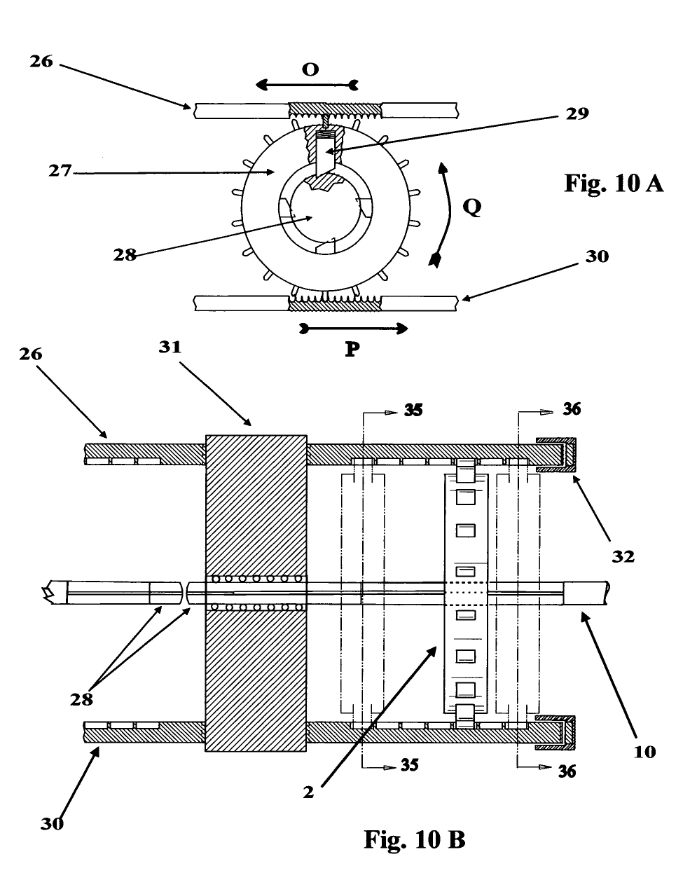

FIG. 10A Frontal view of Drive Shaft, 28, as it protrudes through Gear Head,27 and FIG. 10B Partial lateral view of motor assembly showing positions of Gear Heads 35 and 36.

26: Upper Rotor Disc B which interacts with top portions of both anterior and posterior Gear Heads

27: Gear Head

28: Frontal portions of both anterior and posterior Drive Shafts protruding through Gear Head

29: Peg catch mechanism, (spring prong) for torque dynamics of Drive Shafts

30: Lower Rotor Disc, C, which interacts with Gear top portions of both anterior and posterior Gear Heads

31: Central Support for Drive Discs

32: Braking mechanism for Drive Discs. Mechanism is applied upon depression of brake pedal which simultaneously brakes the wheel brakes

2: Posterior Gear Head

10: Posterior Drive Shaft

35: Gear Head position in which there is no torque or turning motion of Gear Head. This is necessary at times when the posterior Drive Shaft has to protrude further forward through the support column and into the anterior drive sector to take the Gear Head displacing the anterior Drive Shaft for the purpose of initiating “reverse” drive. Posterior Gear Head is not engaged for torque as its Drive Shaft proceeds still farther forward for increasing reverse direction speed motion.

36: Farthest row position for posterior Gear Head

O: Arrow showing direction of spin of “B” disc.

P: Arrow showing direction of spin of “C” disc.

Q: Arrow showing direction of torque for gear head, 27.

### Page 10

Structural Depiction of Drive Assembly, (motor) as seen from above 37: Hydraulic Actuator for synchronous and asynchronous positioning of anterior and posterior Drive Shafts, 41 & 44

38: Turbine Shaft for generating electrical current to Induction Generator

39: Turbine Propeller which provides torque for generation of electrical current to the Induction Generator

40: Induction Generator

41: Anterior Drive Shaft leading to front gear box and wheels

42: Hydraulic Actuator for synchronous and asynchronous positioning of anterior and posterior Gear Heads, I, along the horizontal track of the Drive Shafts, H & E

43: Outline of Rotor and Stator discs: A, B, C, & D

44: Posterior Drive Shaft leading to rear gear box and wheels

45: Gear Heads, (Drive Shaft gear rotors—anterior and posterior)

46: Computer/Controller

34: Polarity Switching & Power Source Module: wired to electromagnets for polarity switching & electrical current. (Note: Full wiring for A, D, F, J, & K to & between other components and electromagnets is not shown. See P. 12.)

### Page 11

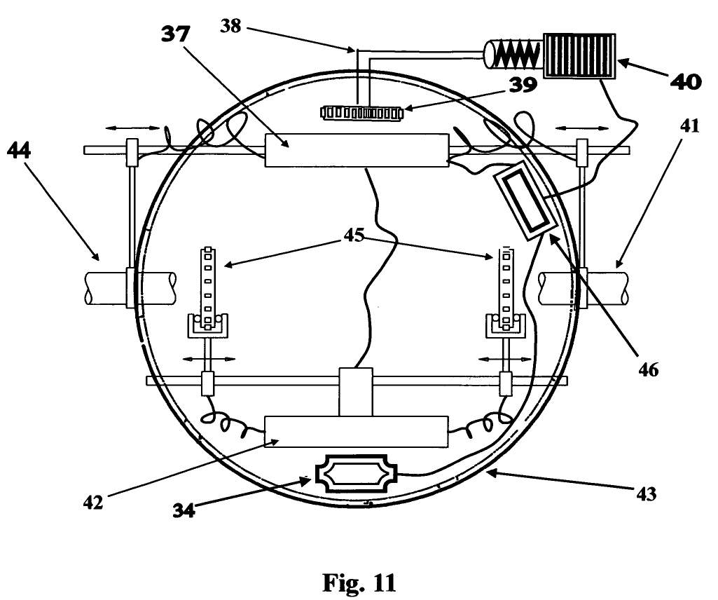

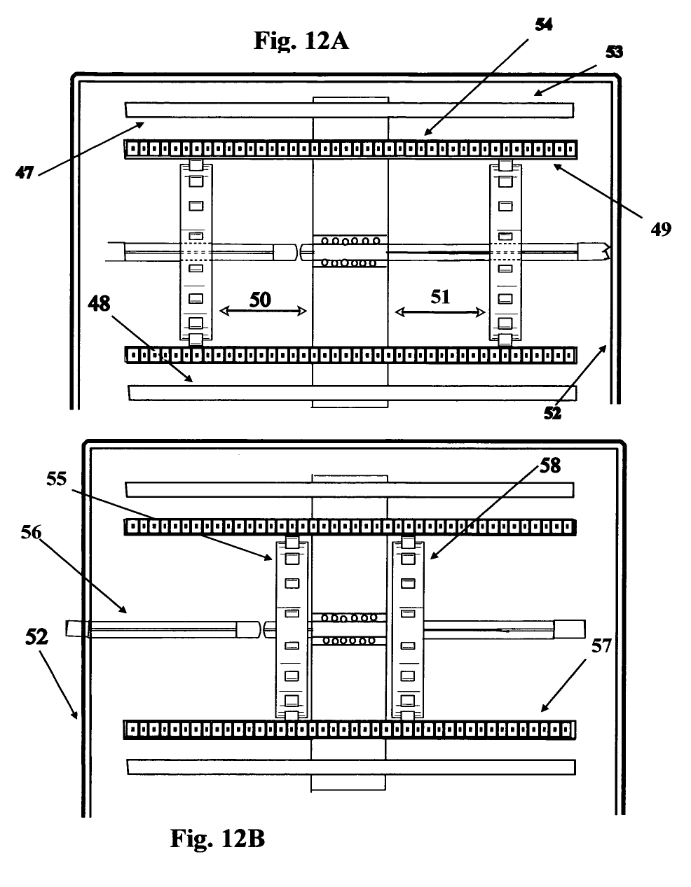

FIG. 12A shows a depiction of motor assembly Showing configuration of Drive Heads and Drive Shafts in “Drive Mode.” The Gear Heads are equidistant on Rotor Discs at a specified row for a specified speed.

FIG. 12B shows depiction of motor assembly showing configuration of Drive Heads and Drive Shafts at initial stage for “Reverse.”

47: The underside of Disc “A,” (Stator Disc A) into which are structured electromagnets that will interact with permanent magnets on Rotor Disc immediately below it forming a force field.

48: Surface of Disc “D,” (Stator Disc D) into which are structured elecromagnets that will interact with permanent magnets on the underside of Rotor Disc C immediately above it.

49: Underside of Rotor Disc B within which are the grooves for gear meshing with the Gear Heads, 15 & 58.

55: Anterior Gear Head in position for initiating reverse drive. The posterior Gear Head,

58: will not be engaged for torque gear engagement. As this anterior Gear Head is driven to higher rows in its sector, the resulting effect will entail higher speeds “in reverse.”

56: Anterior Drive Shaft after having “deferred” its Gear Head to the advancing posterior Drive Shaft.

57: Surface of Rotor Disc C into which are grooves for gear meshing with the Gear Heads, D & G.

58: Shows posterior Gear Head in position for non-engagement for gear torque. It is the maximum position toward center, (Neutral). This is the point, also, at which, (with manual gear shift) “reverse” is initiated by action of forward positioning of posterior drive shaft with anterior Gear Head, 55.

50 & 51: Show equidistant positioning of both front and rear Gear Heads with respect to the gear rows.

52: Protective Shield for EMI and EMR containing any adverse electromagnetic rays

53: Top surface of Stator A Disc upon which are positioned such as the Induction Generator, Controller, and the Polarity Switching mechanism module.

54: Top surface of Rotor Disc B into which are structured the Permanent magnets that will interface with the Electromagnets of the Stator Disc A.

### Page 12

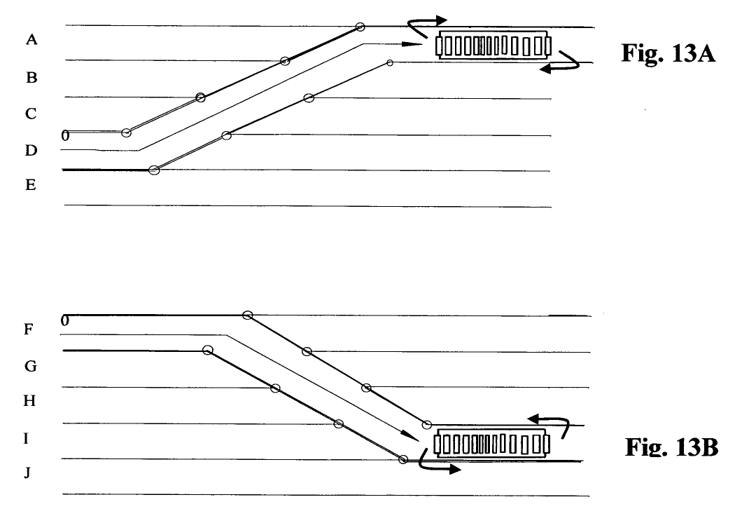

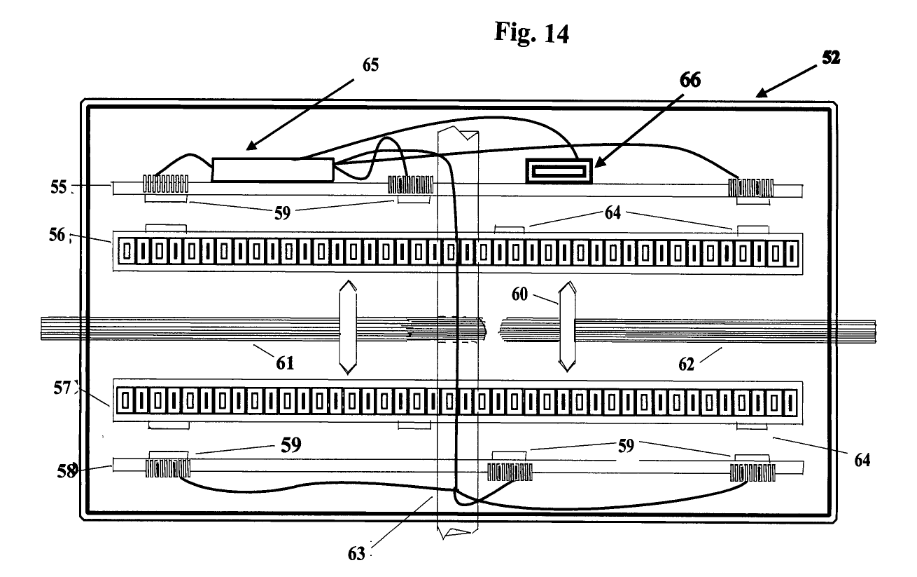

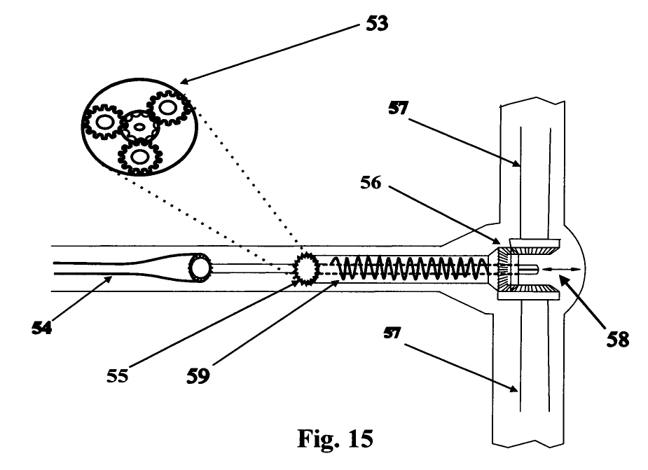

FIG. 13A Increasing Speed, (simultaneous to FIG. 13B): gear head transits towards the peripheral edges of B & C discs, “Stacked Configuration” A-B-C-D.

A: Shows Gear Head transiting to higher rows of B & C discs thus higher speed, simultaneous with “FIG. 13B”

B: Gear Head has bypassed this row.

C: Gear Head has bypassed this row.

D: Gear Head has run along this row then transited to row A, bypassing rows C and B.

E: This row is not immediately engaged for this transit event.

FIG. 13B Increasing Speed, (simultaneous to I): gear head transits towards the peripheral edges of B & C discs.

F: Gear Head has run along this row then transited to row I, bypassing rows G and H which simply effectuated the appropriate switching levers to allow gear head to go to row I.

I: Shows Gear Head transiting to higher rows of B & C discs thus higher speeds, simultaneous with “I”

J: This row is not immediately engaged for this transit event.

### Page 13

Page 12 is a Lateral View of Motor Assembly encased in EMR/EMI Shield.

55: Stator Disc—This is the uppermost, stationary, disc upon which are, optionally, located such items as the polarity switching mechanisms, tachometer, encoder, etc. They can, also, be located elsewhere alongside the battery, generator, transformer, (etc.) units. It is one of the two discs upon which are positioned the elecromagnets that will interact with permanent magnets immediately below it on B.

56: Upper Rotor Drive Disc—This disc will be one of the two which will spin providing torque for the shafts, G & H. It will feature permanent magnets which will have both attractive and repelling force with electromagnets.

57: Lower Rotor Drive Disc—This disc will be one of the two which will spin providing torque for the shafts, G & H. It will feature permanent magnets which will have both attractive and repelling force with electromagnets.

58: Stator—This is the lowermost, stationary, disc upon which are positioned electromagnets

59: Electromagnets—They will interact with permanent magnets on the facing B and C discs for attraction and repulsive forces determined by a polarity switching mechanism.

60: Rotary Gear Head. It meshes with grooves and striations on facing surfaces of discs B and C.

61: Drive Shaft for rear gear box and wheels

62: Drive Shaft for front gear box and wheels

63: Central support column through which rear drive shaft passes through to opposite side of rotation sector to engage anterior Gear Head for the purpose of Reverse Drive.

64: Permanent Magnets on rotor discs B and C interact with the electromagnets on discs A and D to effectuate dynamic spin of rotor discs B and C which, in turn, provide a means for the torque force exerted on gear heads.

65: Polarity Switching Module—It switches the polarity of the electromagnets from S to N and N to S.

66: Transformer—turns current conducted from generator into higher voltage supplied to the electromagnets.

52: Protective Shield from Electromagnetic Radiation & Electromag. Interference. It houses Roto-Synchronous Motor

### Page 14

Page 14 shows a rear section of drive shaft showing gear box and axles. 53: Planetary gear system used as a rotary speed increaser. One will be used in this posterior Drive Shaft segment as well as in the anterior Drive Shaft segment for increasing the RPM's of the drive shafts.

54: Segment of the Drive Shaft leading from the Drive Disc motor.

55: Receptacle gear teeth of the inner surfaces of the Drive Shaft. These corrugated surfaces accommodate the planetary gear system allowing it to telescope laterally as required by the action of the drive shaft.

56: Rear Gear Box—The Drive Shaft protrudes through it as it changes its position forward and rearward.

57: Rear Axles for rear wheels.

58: Rear extremity of Drive Shaft indicating its thrusting and retracting action with respect to Gear Head movements as it transits between B and C Rotor (Drive) Discs.

59: Torsion Spring (option) for smooth gear change eliminates “shift shock.” It may be substituted by hydraulic system.

### Page 15

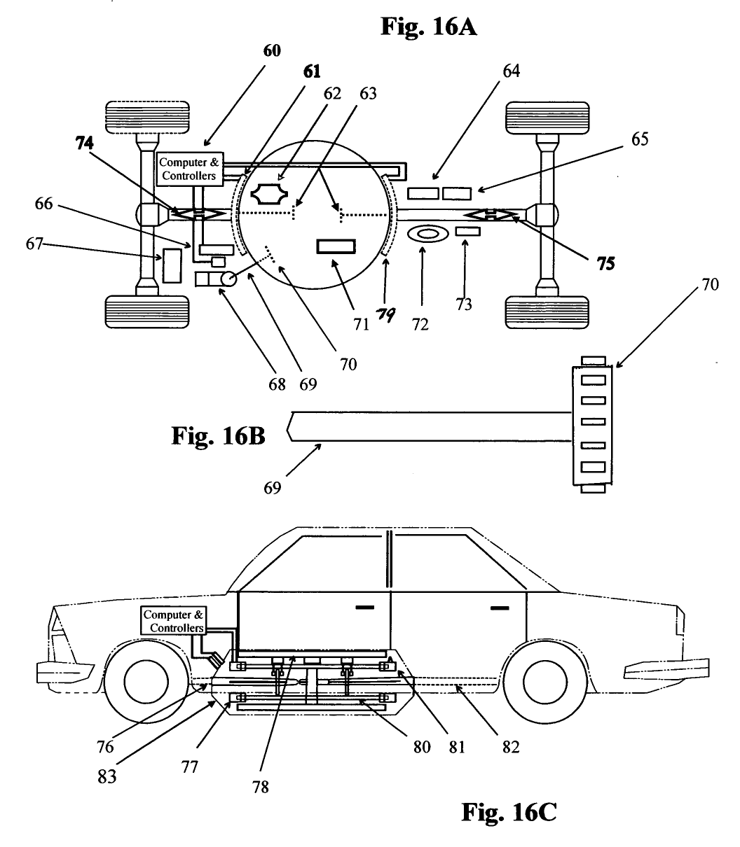

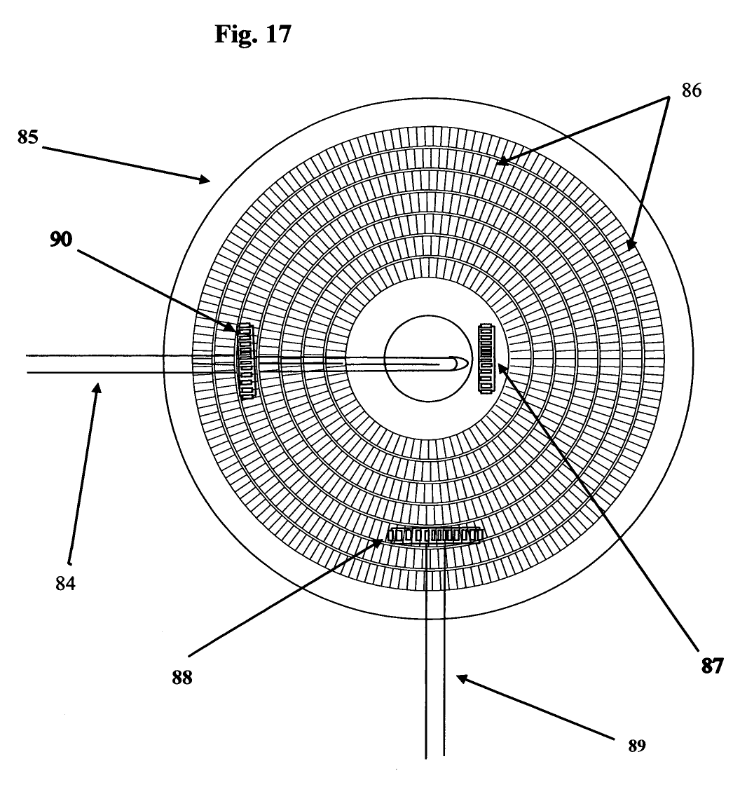

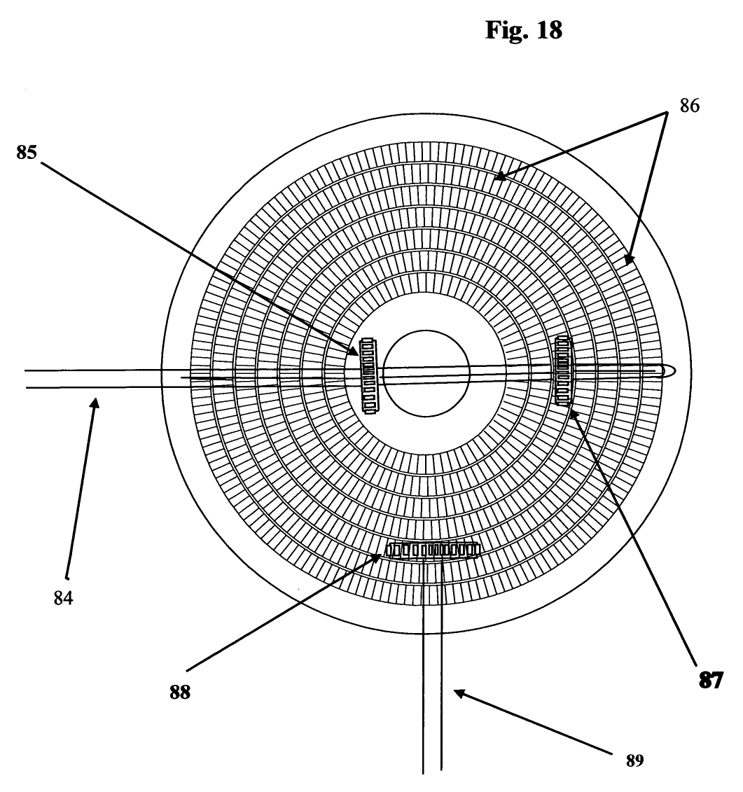

FIG. 16A: Top Side, (view from above) of chassis of automobile

FIG. 16B: Turbine: Rotor is turned by “B” and “C” discs for torque energy to generator

FIG. 16C: Side of motor assembly as it would be structured into a conventional automobile

60: Computer and Controller module

61: Friction Braking Shoe—a set for each disc B and C. They work in-concert with conventional braking system. They will slow the spin of the Rotor Discs once the operator of the vehicle depresses the brake pedal to slow the automobile. At the onset of braking mechanism, the Prongs of gear heads P. 9-D will withdraw from both front and rear Drive Shafts. As the brake pedal is held, gear heads will recover, (down shift) to neutral position. For momentary brake depression, then release, the gear heads will recover, (fall to lower courses) consequent to length of time brake pedal is held then resume torque activity at course tier, (m.p.h.) whereupon accelerator is depressed.

62: Polarity Switching/Commutator Module—It switches the polarity of the electromagnets from S to N and N to S, (graphics p. 1-4 & 5-11).

63: Gear Heads

66: Braking and Accelerating control pedals

67: Battery. The battery is necessary for “surge” to initiate electromagnetic system.

68: Induction Generator. Provides current to elecromagnets and components requiring electrical current.

69: Turbine Shaft connected to generate current for battery and electromagnets.

70: Turbine Rotor—meshes with striations and rows of B and C Rotor Discs. Turbine rotor is connected to generator, “I” above, to generate current for electromagnets, battery, and other electrical current for the operation of the automobile.

71: Transformer—takes the AC and converts it to higher-voltage current.

79: Friction Braking Shoe. As a pair, they work in conjunction to slow the spin of the Rotor Discs once the operator of the vehicle depresses the brake pedal to slow the automobile.

73: Encoder. It provides tachometer feedback to computer/controller for speed adjustment.

74: Anterior planetary gear system for speed increase, (torque acceleration).

75: Posterior planetary gear system for speed increase, (torque acceleration).

76: Anterior Drive Shaft

80: Rotor Disc “C”

78: Stator Disc “A”

81: A Brake shoe for Rotor Disc “B”

82: Posterior Drive Shaft

83: Protective Shield, (as EMG/EMI containment unit for motor assembly)

### Page 16

Page 16 shows C-Rotor at “Forward” Propulsion Configuration

84: Drive Shaft for astern gear box and propulsion blades of a watercraft vessel

85: Drive Disc “C” as seen from above vantage point

86: Rows into which Gear Heads, G, run and between which they transit.

87: Non-engaged, non-meshing, Gear Head assembly for reverse torque in watercraft. Held in place by the Hydraulic Actuator for positioning system, (not seen here); See Graphics page 10F.

88: Rotor for Turbine mechanism. It transits the various rows as the need for electric power requires.

89: Turbine Shaft that leads to the Induction Generator

90: Gear Head assembly engaged, meshing position held in place by positioning Hydraulic Actuator, (not seen here); See Graphics page 10-F

### Page 17

“Reverse” Propulsion Configuration C-Rotor Disc.

84: Drive Shaft for astern gear box and propulsion blades of a watercraft vessel

85: Gear Head assembly in neutral, “non-engaged,” non-meshing position held in place by Hydraulic Actuator for positioning of Gear Heads, (not seen here); See Graphics page 10-F

86: Rows into which Gear Heads, G, run and between which they transit.

87: Gear Head “engaged” for reverse torque in watercraft. Held in place by Hydraulic Actuator for positioning of Gear Heads, (not seen); See Graphics page 10F. This Gear Head is not necessary in non-mobile generator products.

88: Rotor for Turbine mechanism. It transits the various rows as the need for electric power requires.

89: Turbine Shaft that leads to the Induction Generator

### DETAILED DESCRIPTION—PREFERRED EMBODIMENT

This Roto-Synchronous Electric Motor being introduced is composed of two rotating inner discs, (Rotors B&C—See page 13 of graphics) and two stationary outer discs, (Stators A&D—See page 13 of graphics). This electric motor uses the attraction and repulsion physical dynamics of both permanent and electro-magnets and a “polarity switching” mechanism to accomplish opposing spin of two discs and thus “mobility” of an automobile vehicle. It uses sets of specifically-arranged magnets, (graphics Pages 14) and a magnet polarity switching mechanism to set up an attractive and repulsion dynamic for the express purpose of causing the two discs, B & C, to spin in opposite directions. When voltage is applied to the electromagnets, and a command for “Drive,” “Reverse,” etc. is initiated, the result is a turning motion—spin—(clockwise and counterclockwise) of the set of discs, (Drive Discs (rotors) B & C) and consequent torque rotation of a set of Gear Heads & connected Drive Shafts and consequent mobility of the vehicle. Voltage supplied to such a motor can vary the speeds and torques that it provides. As an AC electric induction motor, it rotates with relatively constant speeds proportional to the frequency of the supply power and effect of computer-controlled speed modification—such computer-controlled impetus, itself, is controlled by the operator of the vehicle by his manipulations of the typical means: accelerator, gear shift, brake pedal, etc. of conventional automobiles. The forceful rotation of the conventional washing machine while in the rinse cycle exemplifies the dynamic spinning action to be achieved by the spinning force of the two drive discs of the Roto-Synchronous Electric Motor indicated above.

In this Roto-Synchronous Electric Motor, the four disks, mentioned above, are laterally set, one atop the other, (A,B,C,D—top down) and spaced apart by a support column that intersects the disks at their centers. Disks A and D are Stators; Disks B and C are Rotors. The four discs may measure, approximately, the width of the vehicle in diameter. The rotors will spin in opposite directions with respect to each other. Upon the planes of their mutually facing surfaces, they will have raised lines that radiate from their respective centers terminating at the peripheral edges of their common circumference. Such raised lines, (thus forming grooved courses) will serve as the connecting, (meshing) points for the two anterior and posterior gear head assemblies: See graphics pages 6-3 & 7 and 12-A-J. The surfaces of the two mutually facing disks will be identical, (in mirror aspect, graphics p. 7) except that they spin in opposite directions. This would be similar to two bicycle wheels that face each other, spinning in opposite directions.

The raised, radial, lines of the facing surfaces of disks “B” & “C” serve as mesh points for the gear-head teeth assembly, (graphics p. 7-3). Such gear teeth will mesh with the lines to provide the turning motion, (clockwise and counter-clockwise torque) of the upper and lower rotor disks, “B” & “C,” upon the anterior and posterior gear heads.

The two gear head assemblies will be allowed to slide, forward and rearward, along the raised lines of the disk surfaces, (graphics p. 7-3) for higher and lower speeds. Moreover, the two gear head assemblies will “transit” from one row to the next, (upper or lower) by regular intervals of “Runner Switch Guides,” (graphics p. 8-22) that will permit the gear head assemblies, (anterior and posterior) to “transit” to, or from, an adjoining row along the raised lines. It will move along, row after row, from one tier to the next, (graphics p. 7-10) toward either the extremity of the circumference of the facing disks or toward their centers, (origin) at the “neutral” position of the Drive Disks. Tier transits, graphics p. 7-10, also allows for disparity of groove-lengths necessary for gear-head meshing. That is, discs B & C will be capable of “sector sliding” at tier transits, (graphics p. 7-10) to maintain integrity of the spacing of the gear head teeth and the radial striation lines, graphics p. 7-3 necessary for gear meshing and torque.

In “Drive” mode, when there is forward or rearward torque resistance, (ie. due to hill incline) the gear heads will fall to lower course levels, but the velocity of disks will increase proportionally to compensate for maintenance of set speed and provide higher torque force and, so, higher traction. Moreover, even if velocity of disks remain at constant rpm's, (are not controlled for variable speed) the gear-head assemblies will fall to lower course levels, (thus gaining higher torque power) under stress of increased resistance—but as rpm's of discs remain the same. This is by the dynamics of physical law and is done automatically, (programmed) as determined by measurable resistance sensing and incremental compensation for maintaining speed control. Such circumstance is realized when a vehicle conventionally travels on an incline or when pulling another vehicle in tow.

Tier Sectors: At regular intervals, going from the center to the periphery of the Disks “B” & “C,” the raised linear guides will not match the gear head assembly teeth due to the space-gap measurements between the teeth and the striated raised lines of the Drive Disk surfaces. By the physical nature of lines originating at a common center and projecting out toward to an extremity, the spacing between such lines, necessarily, increase as they project out toward peripheral edges. So, desired meshing of gears will occur then gnashing will become a factor. Therefore, In this case, an adjustment has to be made in accordance with these physical dynamics. This correcting adjustment entails a “tier” structure whereby a set number of rows, (courses) of each Drive Disk, B & C, will differ in linear spacing from its adjacent set of rows as they project out toward peripheral edges. So, the tier sectors will have a catch mechanism timed to connect with an adjacent tier to accommodate the necessarily different spacing of each tier, (drawings p. 7-D, E, F,) etc. These tiers may be on an independent rotational catch-mechanism continuum. They rotate, interchangeably, (respectively D, E, F, etc.) as the gear head transits from lower tier to the higher, (lower speed to higher—and vice versa). This configuration will accommodate for the mathematically calibrated spacing of the Gear Head gap measurement, (teeth spacing) as the Gear Heads proceed from Drive Disk centers outward to their peripheral edges.

Course Switch Mechanism: At each row, there will be sets of lever switches, (graphics p. 8-22) that will instantaneously switch in one direction or other to allow the gear head to transit to, or from, a row left or right, (higher speed/lower speed). The switches will be so aligned that, as the gear head assembly, “switches through” one row to the next, the subsequent switch on adjacent row will be open immediately after previous switch so as not to allow gear head to travel along row at all but to form a “relay switching” channel that can take the gear head from the lowest tier to the highest tier, “switching out or in,” switch by switch. This is, also, the method by which the operator of the automobile will achieve the highest speed in the shortest period of time—paralleling in synchrony the quickest depression of the accelerator pedal. That is, the gear head assembly transits outward toward peripheral edges in measured increments as calibrated with the position of the accelerator pedal. Moreover, the switches are necessarily programmed to respond to the depression of the accelerator—for higher speeds, as well as depression of the brakes—for decreasing speeds.

“Polarity Switching” mechanism of Electro-Magnets—module for electromagnets will effect synchronous spin of both B & C discs. That is, the electromagnet will, (depending on relative position to permanent magnet) either attract or repel the permanent magnet. In the case wherein the regular magnet and the electromagnets are approaching each other, (graphics p. 1, 4, & 5) the polarity of the electromagnet is opposite the permanent magnet. Once the permanent magnet is at the point of passing the electromagnet, (graphics p. 2, 5) a polarity of the electromagnet “shifts” to the “same polarity” of the permanent magnet. This will effect a repelling force upon the permanent magnet, (graphics p. 3 & 5). The electromagnets and permanent magnets being on opposite discs, and interfacing each other in close proximity, (graphics p. 13) will, thus, bring about the dynamics for spin of the B and C discs. Mobility of the automobile vehicle is, in this way, effectuated by both the attractive force of the magnet sets of opposite polarity and the repulsive force of the magnet sets but with the same polarity after polarity switching, (of electromagnet). The polarity switching module, (graphics p. 13-65)

Alternative placement of the permanent magnets and electromagnets: They may be “skewed/staggered” to the effect that, for each facing set of two, (North/South) magnets on the two drive discs, the first set achieves full attractive force, the second set achieves ¾ attractive force; the third achieves ½ attractive force; and the fourth achieves ¼ attractive force as they approach and interface each other. Upon moment of ¼ attractive force for the fourth magnet, the first achieves full attractive force again. By this method, the two rotating Drive Discs will achieve maximum steady-state torque force. This Roto-Synchronous magnetic force will be complementary for maximum effort. Each in turn will be first, second, third, and fourth in synchronous attractive force in the process of rotating the upper and lower Drive Discs as they interact with their stationary, non-rotational facing plates. Proportional pull is evenly distributed around Drive Disc. Whatever the total number of magnet groups, they should be in paired sets so they may go through, (repeat) the above-stated 1-4 stages: 4, 8, 12, 16, 20, 24, 28, etc. so that the maximum attractive force for each four-set group can be achieved. That is, each group of four is synchronously identical. The number of groups of magnets, each calibrated as above, is arbitrary. The number of sets depends upon the diameter of the rotor discs which, itself, depends upon the width of the vehicle thus dictating the circumference.

### OPERATION OF INVENTION

The manner of operating the Roto-Synchronous Electric Motor, for the operator of a conventional automobile, is, manually, the same, except for “ignition:” The operator uses the typical gear shift lever, brake pedal, accelerator pedal, and steering wheel in the same manner as he would with the typical automobile except there is no “ignition” to start an automobile that utilizes the Roto-Synchronous Electric Motor herein being presented. The usual key ignition is dispensed with. There is no combustion, (firing of pistons) and carburetion event sequences for “ignition.” The system is simply “turned on” in the same manner as would be a light switch for a table lamp. A key may be necessary for the switch; however, an “ignition” event is not a part of the protocol for the Roto-Synchronous Electric Motor.

The operation of an automobile that is equipped with the Roto-Synchronous Electric Motor herein presented entail that, for mobility, a computer-programmed command, (graphics p. 15-60) effectuates a sequence for “drive,” “reverse,” “neutral,” “increase acceleration,” and “deceleration” upon impulse of automobile operator from the passenger compartment. Switching the automobile to “on” initiates a command operation for dynamic of spin of discs, (graphics p. 13-56 & 57) between which are interposed an anterior drive shaft, with gear head assembly, (graphics p. 13-62) for front wheels, and a posterior drive shaft, with gear head assembly, (graphics p. 13-61) for rear wheels. At this point, (spinning discs) the gear head assemblages are in the “neutral” position, (graphics p. 7-12). They are not engaged in the rows/courses, (graphics p. 7-3) for any torque action. Upon initiation for “drive,” the operator of the automobile puts the gear shift into the “drive” position then presses the accelerator, (graphics p. 15-66). These actions cause both the interposed drive shafts, (graphics p. 13-61 & 62) and gear head assemblages, (graphics p. 13-60) to engage the lowest courses of drive discs B and C and to “transit out” to higher courses commensurate with the degree of depression of the accelerator pedal. As the gear head teeth mesh with the striation grooves of the drive discs, (graphics p. 7-3) torque power is effectuated for the drive shafts for the necessary turning motion for front and rear wheels and thus the mobility of the automobile. The more the accelerator is depressed, the higher the course levels reached by the two drive shaft gear-head assemblages, (as they transit out away from centers of discs) and the consequent higher speeds in miles per hour. Upon initiation of “Cruise Control” initiation, an operator may remove foot from accelerator whereby the automobile will continue, and maintain, attained speed. Upon braking action of operator, Cruise Control is discontinued and brakes are applied to front and rear wheels as in conventional automobiles, but, also, there is a braking action applied to the peripheries edges of the drive discs themselves, (graphics p. 15-61, 81).

For “reverse” mobility of the automobile, the shift lever in a passenger compartment of an automobile equipped with this novel Roto-Synchronous Electric Motor is put into the “reverse” position. This action will cause the posterior drive shaft to:
1. advance farther forward through the central support column, (graphics p. 8-21, 13-63);
2. divest itself of torque interaction with its usual gear head assembly, (posterior gear head is disabled for forward mobility—graphics p. 8-20, 11-58); and
3. engage torque action with the anterior gear head assembly as anterior drive shaft, (graphics p. 8-24) retracts, (anterior gear head is enabled for rearward mobility—8-23, 11-50).

This configuration for “reverse,” provides that the rear wheels, only, will be used for “reverse.” The anterior drive shaft will not be engaged, so front wheels will not participate in reverse mobility of the automobile. Otherwise, in “drive,” all four wheels are engaged in mobility of the vehicle.

### DESCRIPTION—ADDITIONAL EMBODIMENTS

Additional embodiments would entail application to such conveyance vehicles as watercraft, commercial, and non-commercial trucks, buses, and aircraft. According to features of present invention, adaptations are realizable essentially relevant to the singular dynamics of the rotary, dual-disc, mechanism utilizing electromagnet and permanent magnet means to cause mobility of a passenger automobile and various other passenger conveyance vehicles such as trucks, motorcycles, and water craft, in addition to non-conveyance, non-mobile, apparatuses such as electric generators.

Watercraft: Graphics Page 16 Shows the Roto-Synchronous Electric Motor as a possible embodiment for a watercraft vessel. Such vessel may feature an outboard or an inboard application for this motor. This drawing indicates the forward propulsion configuration of the drive shaft and contiguous Gear Head Assembly 90 as meshed but the Gear Head Assembly 87 for “reverse,” as being in a non-engaged, non-meshed, position. It remains in this position until such time when Drive Shaft A thrusts forward to engaged it for reverse drive on the initiation of the operator of the craft.

Graphics Page 17 Shows the Roto-Synchronous Electric Motor for a water craft in the reverse propulsion configuration of the Drive Shaft and contiguous Gear Head Assembly. Gear Head Assembly 85 takes the neutral, non-engaged, non-meshed, position. The Gear Head Assembly 87 is engaged and meshed for reverse propulsion of the craft. In both cases, the discs do not reverse direction of spin. The position of the two Gear Head Assemblages respond to the operator's handling of the manual gears.

Graphics page 13 Shows the Component system for a water craft; however, Drive Shaft 62 will not be included this component set. This element 62 is specified for road vehicles: passenger automobile vehicles and load bearing trucks.

Operation of Alternative Embodiment: Watercraft vessels: Simply, the watercraft, small boats as well as larger seagoing cruise liners will operated under the same principle of mutually facing discs that spin in opposite directions, further that such spin is effectuated by specifically-placed magnets and electromagnets that interact with each other on the spinning surfaces of the facing discs by a polarity switching process of the electromagnets thus causing spin of the discs. According to the dynamics of the drive mechanism of the Roto-Synchronous Electric Motor, the Drive Shaft, (Graphics pgs. 13-61, 16-84, 17-84) pertains to and presupposes the torque requirements of above-stated water craft vessels. The operator manual controls will differ in application as the dictates of watercraft dictate.

Aircraft—Propeller Propulsion: Graphics Page 16 Shows the Roto-Synchronous Electric Motor as a possible embodiment for an aircraft apparatus such a helicopter or propeller-driven airplane. Such craft will feature a structural adaptation for the application for this motor. This drawing indicates the propulsion configuration of both drive shafts, 84 & 87 and contiguous Gear Head Assemblages, 85 & 90 as meshing and engaged for torque. Moreover, in the case of a helicopter, a necessary universal gear segment may be a factor contiguous to either the posterior or anterior Drive Shaft for means of an angular torque accommodation for an overhead propeller. The rear propeller will require this angular torque at the tail end of the craft. Accordingly, such craft will also use a modified component layout as is illustrated on Graphics page 13.

Non-passenger/remote-controlled vehicle: Such vehicle can be easily adapted for purposes of remote control in circumstances wherein it is expedient that a human being not be present in the vehicle. These can be either for terrestrial mobility travel or for flight propulsion or hovering without the in-vehicle manning by a human being.

Non-conveyance, non-mobile apparatus: Graphics Page 16 Shows the Roto-Synchronous Electric Motor as a possible embodiment for an apparatus such a stationary power generator. Such apparatus will feature a structural adaptation for the application for this motor. This drawing indicates the torque shaft necessary that will have a Gear Head assemblage 90. It does not require Gear Head assembly 87 as it will not require reverse motion. Therefore, in this illustration, 87 should be understood as inconsequential in reality. It is only for illustrative purposes only to the extent this illustration has alternative applications. For this embodiment, only one Drive Shaft A is necessary.

Motorcycle: A motorcycle, (motorized bicycle) may utilize this Roto-Synchronous Electric Motor apparatus in such manner that the component system can be modified. The two spinning discs will be operated in a vertically position and following the component scheme as indicated in illustration on Graphics page 6 whereby, even, a motorcycle may be propelled in reverse, in addition to forward drive.

### CONCLUSION, RAMIFICATIONS, AND SCOPE

Accordingly, the reader will see that the above-presented novel idea for a fuelless passenger automobile is an item that is in great need. In this regard, it should be ascertained that environmental pollution will be decidedly diminished, if the present invention were to be generally put into use in the United States, as well as in other countries. Moreover, the concerns for reliance on other oil-producing countries will be assessed.

Concern for “Electro-Magnetic Ray Shielding:” If magnetic fields become a matter of concern with regards to operation of the Roto-Synchronous Electric Motor herein being presented, magnetic fields can be re-routed around objects: See graphics p. 11-52 & 13-52. This is a form of magnetic shielding. By surrounding an object with a material which can “conduct” magnetic flux better than the materials around it, the magnetic field will tend to flow along this material and avoid the objects inside. This allows the field lines to terminate on the opposite poles, but just gives them a different route to follow. Shielding may be accomplished with one, or a composite of: Co-Netic AA, Co-Netic B, Co-Netic alloys, Mu-metal, or some other appropriate material and/or method.

All in all, the prospect of driving from one end of the country to the other without ever having to “fill up” for gasoline should impress anyone who is serious about saving money, preserving health, doing something dramatically different for the country, or just, simply, doing the right thing for self and others.

What is claimed as new and desired to be protected by Patent is set forth in the appended claims:

1. A roto-synchronous electric motor apparatus for propulsion of a conveyance vehicle that does not use gasoline, solar energy, nor fuel cells as sources of power means for mobility comprising:
a) two horizontally facing rotor discs of variable diameter, said rotor discs providing momentum for torque of an interposed drive shaft connecting to a front gear assembly of said conveyance vehicle and said torque for an interposed drive shaft connecting to a rear gear assembly of said conveyance vehicle;
b) one of said two horizontally facing rotor discs being an upper rotor disc member;
c) one of said two horizontally facing rotor discs being a lower rotor disc member;
d) an upper stator disc horizontally facing the top planar surface of said upper rotor disc member;
e) a lower stator disc horizontally facing the bottom planar surface of said lower rotor disc member;
f) an electromagnetic polarity switching means comprising at least of an array of electromagnets affixed to bottom planar surface of said upper stator disc and an array of electromagnets affixed to top planar surface of said lower stator disc;
g) said electromagnetic polarity switching means further comprising at least of an array of magnets affixed to top planar surface of said upper rotor disc member and an array of magnets affixed to bottom planar surface of said lower rotor disc member;
h) a battery source means for providing at least electric current for said electromagnetic polarity switching system;
i) a storage capacity means for storage of excess electric power;
j) a turbine means for enabling a generator apparatus to produce alternative electric current for at least said electromagnetic polarity switching system and for said storage capacity means;
k) said array of electromagnets and said array of magnets means for mutually attracting and repelling dynamics as said array of electromagnets and said array of magnets interface each other sequentially at opposite polarity and same polarity;
l) a central support column means for allowing said two horizontally facing rotor discs to spin, for said upper stator disc to face said top planar surface of said upper rotor disc and for said lower stator disc to face said lower rotor disc;
m) said electromagnetic polarity switching system means of said upper rotor disc and said lower rotor disc to spin in opposite directions around said central support column;
n) said central support column means for said upper stator disc to horizontally face the said top planar surface of said upper rotor disc;
o) said central support column means for said lower stator disc to horizontally face the said under planar surface of said lower rotor disc;
p) an electromagnetic emissions encasement means for security against possible emission of electromagnetic radiation, said electromagnetic emissions encasement means being an encapsulation of said roto-synchronous electric motor apparatus.

2. The roto-synchronous electric motor apparatus of claim 1 wherein said two horizontally facing rotor discs comprise:
a) a rigid material composed of at least a hardened metal having substantial mass means for maintaining momentum of spin of said two horizontally facing rotor discs;
b) a velocity variation means for providing torque to said drive shaft connecting said front gear assembly of said conveyance vehicle and for providing torque for said drive shaft connecting said rear gear assembly of said conveyance vehicle;
c) said velocity variation means comprising at least a symmetrical array of grooved transit gear meshes and striations made into said bottom planar surface of said upper rotor disc member and said top planar surface of said lower rotor disc member, said symmetrical array of grooved transit gear meshes and striations being incremental tier course positions for a gear head;
d) said symmetrical array of grooved transit gear meshes and striations being at least means for gear head meshing for said torque of said drive shaft connecting said front gear assembly and to said torque of said drive shaft connecting said rear gear assembly;
e) said symmetrical array of grooved transit gear meshes and striations further being means for said gear head providing said torque to said drive shaft connecting said front gear assembly and for said gear head providing said torque for said drive shaft connecting said rear gear assembly to run along said symmetrical array of grooved transit gear meshes and striations of said under planar surface of said upper rotor disc and to run along a grooved surface of said upper planar surface of said lower rotor disc;
whereby said roto-synchronous electric motor apparatus can cause said propulsion of said conveyance vehicle without using gasoline, solar energy, nor fuel cells as sources of power means for mobility.
